(19) United States
(12) Patent Application Publication
(10) Pub. No.: US 2016/0061387 A1
(43) Pub. Date: Mar. 3, 2016

(54) ILLUMINATING DEVICE

(71) Applicant: HON HAI PRECISION INDUSTRY CO., LTD., New Taipei (TW)

(72) Inventors: CHUN-WEI LIANG, Tu-Cheng (TW); KUANG-MING HSIAO, Tu-Cheng (TW)

(21) Appl. No.: 14/526,124

(22) Filed: Oct. 28, 2014

(30) Foreign Application Priority Data
Sep. 1, 2014 (CN) 201410439447.9

(51) Int. Cl. F21K 99/00; F21V 5/04; F21V 19/00; F21V 7/22

(52) U.S. Cl. CPC F21K 9/1355; F21V 7/22; F21V 5/045; F21V 5/048; F21V 19/002; F21Y 2101/02

(57) ABSTRACT

An illuminating device includes a circuit board, a plurality of LED (light emitting diode) elements, a first envelope with a first opening, a second envelope with a second opening and a third envelope with a third opening. The LED elements are arranged on and electrically connected with the circuit board. The first envelope covers and faces the circuit board. The second envelope covers and faces the LED elements. The third envelope covers and faces the second envelope. The second opening is coupled to the first opening to surround the LED elements and the circuit board. The third opening is coupled to the first opening to surround the LED elements, the circuit board and the second envelope.

### CROSS-REFERENCE TO RELATED APPLICATIONS

This application claims priority to Chinese Patent Application No. 201410439447.9 filed on Sep. 1, 2014, the contents of which are incorporated by reference herein.

### FIELD

The disclosure relates to an illuminating device, and particularly to an illuminating device with high light intensity performance.

### BACKGROUND

Increasing an angle of light may improve a uniformity of light, which will decrease a light intensity.

### BRIEF DESCRIPTION OF THE DRAWINGS

Implementations of the present technology will now be described, by way of example only, with reference to the attached figures.

FIG. 1 is a cross sectional view of an illuminating device in accordance with an exemplary embodiment of the present disclosure.

FIG. 2 is a cross sectional view of a second envelope and an LED element in accordance with a second exemplary embodiment of the present disclosure of FIG. 1.

FIG. 3 is a cross sectional view of a second envelope and an LED element in accordance with a third exemplary embodiment of the present disclosure of FIG. 1.

FIG. 4 is a cross sectional view of a second envelope and an LED element in accordance with a fourth exemplary embodiment of the present disclosure of FIG. 1.

FIG. 5 is a cross sectional view of a second envelope and an LED element in accordance with a fifth exemplary embodiment of the present disclosure of FIG. 1.

### DETAILED DESCRIPTION

It will be appreciated that for simplicity and clarity of illustration, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

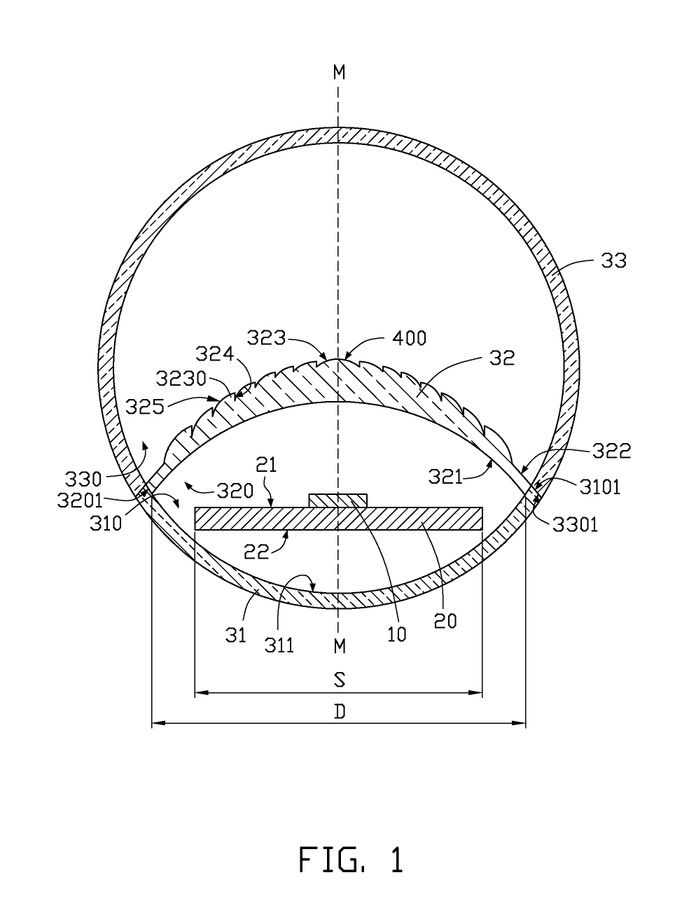

Referring to FIG. 1, an illuminating device comprises a plurality of LED (light emitting diode) elements 10, a circuit board 20, a first envelope 31, a second envelope 32 and a third envelope 33. The LED elements 10 are arranged on and electrically connected with the circuit board 20. In at least one embodiment, the number of the LED elements 10 can be one or more than one. The illuminating device can be formed into a tube-like stricture. In at least one embodiment, the illuminating device can be a bulb-like structure.

The circuit board 20 comprises a first side 21 as a front surface and a second side 22 as a back surface. The first side 21 is opposite to the second side 22. The LED elements 10 are arranged on the front surface which is also the first side 21. In at least one embodiment, a single circuit board can have one or more LED elements.

The first envelope 31 covers a back surface of the circuit board 20. In this embodiment, the first envelope 31 covers the second side 22 of the circuit board 20. The first envelope 31 defines a first opening 310. The first opening 310 faces the second side 22 of the circuit board 20. An inner surface 311 is defined in the first envelope 31. The inner surface 311 faces the second side 22 of the circuit board 20. The inner surface 311 is a reflective surface. In at least one embodiment, the circuit board 20 can be arranged on the inner surface 311 of the first envelope 31 by supporters (not shown). In this embodiment, the circuit board 20 can be arranged on holders (not shown) formed on the two ends of the illuminating device.

The second envelope 32 covers the front surface where the LED elements 10 arranged. In this embodiment, the second envelope 32 covers the first side 21 of the circuit board 20. The second envelope 32 defines a second opening 320. The second opening 320 is opposite to the first opening 310 of the first envelope 31. The second opening 320 faces the first side 21 of the circuit board 20. A second end surface 3201 is defined on the second opening 320. The second end surface 3201 can be coupled to the inner surface 310 of the first envelope 31. The LED elements 10 and the circuit board 20 are surrounded by the first envelope 31 and the second envelope 32 together. A width S of the circuit board 20 is less than a width D of the second opening 320 of the second envelope 32. The second envelope 32 can be a condenser lens. The second envelope 32 is symmetrical about an optic axis M-M of the LED element 10. The second envelope 32 defines a first surface 321 and a second surface 322. The first surface 321 is opposite to the second surface 322. The first surface 321 faces the LED elements 10. The second surface 322 is back to the LED elements 10. The second envelope 32 can be made of transparent material. The second envelope 32 can comprise fluorescent powders.

The first surface 321 is a smooth surface. The second surface 322 comprises a fresnel surface 400. The fresnel surface 400 comprises a raised surface 323 and a plurality of bulges 3230. The raised surface 323 protrudes away from the second surface 322. The raised surface 323 is symmetrical about the optic axis M-M of the LED element 10. The bulges 3230 are located at two sides of the raised surface 323. Each bulge 3230 comprises a flat surface 324 and a curve surface 325. In one bulge 3230, the flat surface 324 is nearer to the optic axis M-M than the curve surface 325 is. The flat surface 324 is parallel to the optic axis M-M. The curve surface 325 protrudes away from the second surface 322.

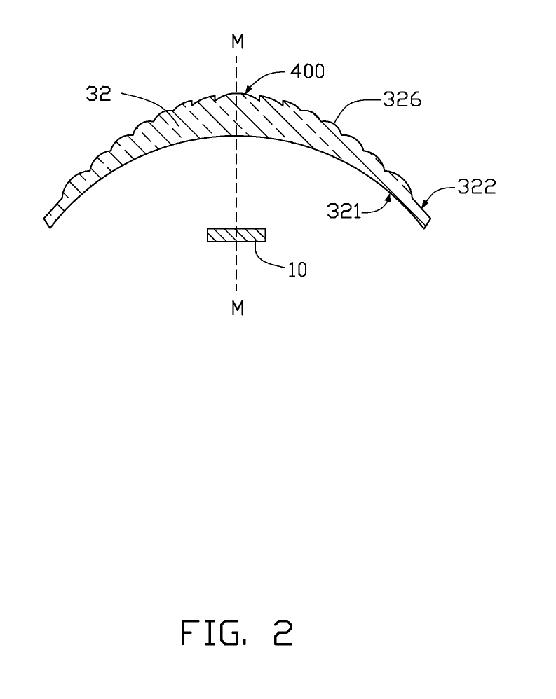

Referring to FIG. 2, the second surface 322 can further comprise a plurality of sub raised surface 326. The sub raised surfaces 326 can be located at two sides of the fresnel surface 400. Each sub raised surface 326 can protrude away from the second surface 322. Curvatures of sub raised surfaces 326 can decrease in turns along a direction away from the optic axis M-M of the LED element 10.

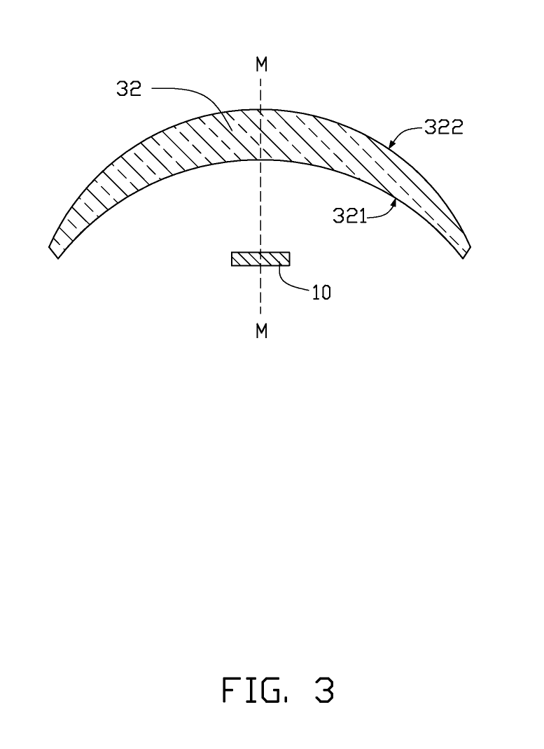

Referring to FIG. 3, each of the first surface 321 and the second surface 322 can be a smooth surface. A curvature of the first surface 321 can be less than that of the second surface 322. Each of the first surface 321 and the second surface 322 can be symmetrical about the optic axis M-M of the LED element 10.

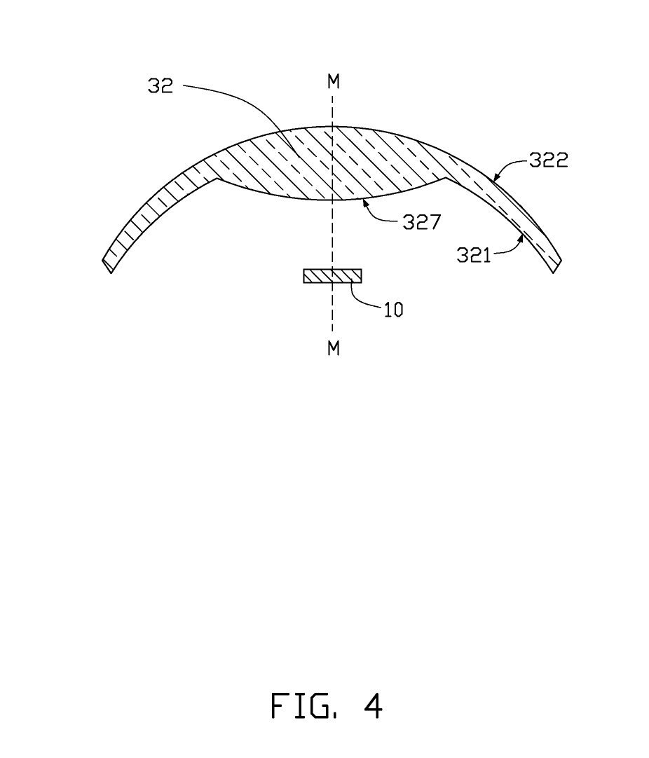

Referring to FIG. 4, the second surface 322 can be a smooth surface. The first surface 321 can comprise a center surface 327. The center surface 327 can be symmetrical about the optic axis M-M of the LED element 10. The center surface 327 can protrude from the first surface 321 towards the LED elements 10.

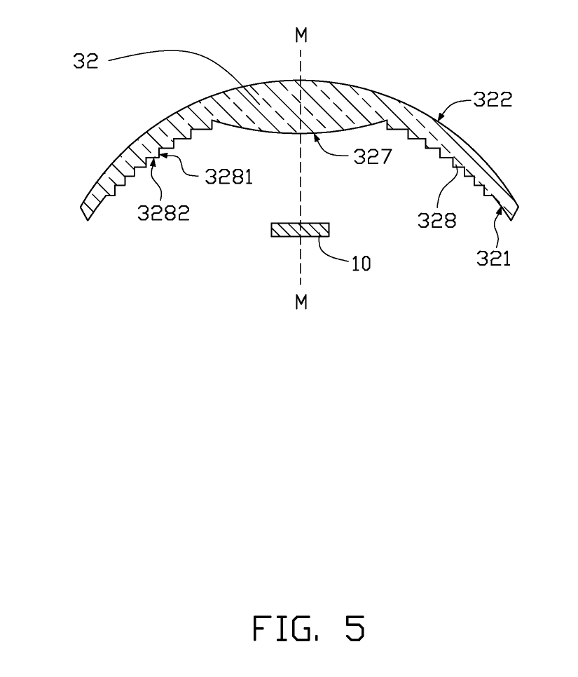

Referring to FIG. 5, the first surface 321 can comprise a plurality of steps 328. Each step 328 can protrude from the first surface 321 towards the LED elements 10. The steps 328 can be located at two sides of the center surface 327. Each step can comprise a third plane 3281 and a fourth plane 3282. Each third plane 3281 can be parallel to the optic axis M-M. Each fourth plane 3282 can be perpendicular to the optic axis M-M. Widths of fourth planes 3282 can decrease in turns along a direction away from the optic axis M-M.

Referring to FIG. 1, the third envelope 33 covers the second envelope 32. The third envelope 33 defines a third opening 330. The third envelope 33 is opposite to the first opening 310 of the first envelope 31. The third opening 330 faces the first side 21 of the circuit board 20. A first end surface 3101 is defined on the first opening 310. A third end surface 3301 is defined on the third opening 330. The first end surface 3101 can be coupled to the third end surface 3301. The second envelope 320, the LED elements 10 and the circuit board 20 are surrounded by the first envelope 31 and the third envelope 33. A cross sectional shape of a space surrounded by the first envelope 31 and the third envelope 33 can be circular. A light transmittance of the second envelope 32 is larger than that of the third envelope 33. The second envelope 32 can be made of transparent material. The second envelope 32 can comprise fluorescent powders.

The embodiments shown and described above are only examples. Many details are often found in the art such as the other features of an illuminating device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. An illuminating device comprising:
a circuit board;
a plurality of LED (light emitting diode) elements arranged on and electrically connected with the circuit board;
a first envelope with a first opening, the first envelope covering and facing the circuit board;
a second envelope with a second opening, the second envelope covering and facing the LED elements, and the second opening coupled to the first opening to surround the LED elements and the circuit board; and
a third envelope with a third opening, the third envelope covering and facing the second envelope, and the third opening coupled to the first opening to surround the LED elements, the circuit board and the second envelope.

2. The illuminating device of claim 1, wherein an inner surface is defined in the first envelope, the inner surface faces the circuit board, and the inner surface is a reflective surface.

3. The illuminating device of claim 2, wherein a second end surface is defined on the second opening, the second end surface is coupled to the inner surface of the first envelope.

4. The illuminating device of claim 1, wherein a first end surface is defined on the first opening, a third end surface is defined on the third opening, and the first end surface is coupled to the third end surface.

5. The illuminating device of claim 1, wherein a light transmittance of the second envelope is larger than that of the third envelope.

6. The illuminating device of claim 1, wherein the second envelope is a condenser lens.

7. The illuminating device of claim 1, wherein the second envelope is symmetrical about an optic axis of the LED element.

8. The illuminating device of claim 1, wherein the second envelope defines a first surface and a second surface, the first surface is opposite to the second surface, the first surface faces the LED elements, the second surface is back to the LED elements.

9. The illuminating device of claim 8, wherein the first surface is a smooth surface, the second surface comprises a fresnel surface, the fresnel surface comprises a raised surface and a plurality of bulges, the raised surface protrudes away from the second surface, the bulges are located at two sides of the raised surface.

10. The illuminating device of claim 9, wherein each bulge comprises a flat surface and a curve surface, the flat surface is nearer to the optic axis of the LED element than the curve surface is, the flat surface is parallel to the optic axis of the LED element, and the curve surface protrudes away from the second surface.

11. The illuminating device of claim 10, wherein the second surface further comprises a plurality of sub raised surfaces, the sub raised surfaces are located at two sides of the fresnel surface, each sub raised surface protrudes away from the second surface.

12. The illuminating device of claim 11, wherein curvatures of sub raised surfaces decrease in turns along a direction away from the optic axis of the LED element.

13. The illuminating device of claim 8, wherein each of the first surface and the second surface is a smooth surface, a curvature of first surface is less than that of the second surface.

14. The illuminating device of claim 13, wherein each of the first surface and the second surface is symmetrical about the optic axis of the LED element.

15. The illuminating device of claim 8, wherein the second surface is a smooth surface, the first surface comprises a center surface, and the center surface protrudes from the first surface towards the LED elements.

16. The illuminating device of claim 15, wherein the center surface is symmetrical about the optic axis of the LED element.

17. The illuminating device of claim 15, wherein the first surface further comprises a plurality of steps, the steps are located at two sides of the center surface, and each step protrudes from the first surface towards the LED elements.

18. The illuminating device of claim 17, wherein each step comprises a third plane and a fourth plane, the third plane is parallel to the optic axis of the LED element, the fourth plane is perpendicular to the optic axis of the LED element.

19. The illuminating device of claim 18, wherein widths of fourth planes decrease in turns along a direction away from the optic axis of the LED element.
